(19) United States
(12) Patent Application Publication
(10) Pub. No.: US 2010/0323261 A1
(43) Pub. Date: Dec. 23, 2010

(54) FUEL CELL SYSTEM

(75) Inventors: Hitoshi Igarashi, Kanagawa (JP); Kenichi Goto, Kanagawa (JP); Ikuhiro Taniguchi, Kanagawa (JP); Kenji Yonekura, Kanagawa (JP); Hayato Chikugo, Kanagawa (JP)

Correspondence Address: DRINKER BIDDLE & REATH (DC), 1500 K STREET, N.W., SUITE 1100, WASHINGTON, DC, 20005-1209, US

(73) Assignee: NISSAN MOTOR CO., LTD., Yokohama-shi, Kanagawa (JP)

(21) Appl. No.: 12/866,535

(22) PCT Filed: Feb. 19, 2009
(86) PCT No.: PCT/IB2009/000329

§ 371 Date: Aug. 6, 2010

(30) Foreign Application Priority Data
Feb. 22, 2008 (JP) 2008-041846

(51) Int. Cl. H01M 8/04

(52) U.S. Cl. 429/436

(57) ABSTRACT

A fuel cell system having a fuel cell, a coolant supply device for circulating a supply of the coolant through a coolant path for cooling the fuel cell, a fuel cell temperature detector for detecting a temperature of the fuel cell, a coolant temperature detector for detecting a temperature of the coolant in the coolant path, and a controller for controlling the amount of coolant circulated by the coolant supply device. The controller selects an operation mode of the fuel cell between a power generation mode and a power generation stop mode and calculates the difference between the detected coolant temperature and detected fuel cell temperature. While the operation mode is the power generation stop mode, the controller increases the amount of the coolant circulated as the difference between the detected coolant temperature and the detected fuel cell temperature increases.

### CROSS-REFERENCE TO RELATED APPLICATIONS

This application claims priority to Japanese Patent Application No. 2008-041846 filed Feb. 22, 2008, which is incorporated by reference herein in the entirety.

### BACKGROUND OF THE INVENTION

1. Field of the Invention

The present invention relates to a fuel cell system for a vehicle, the fuel cell system being configured to stop power generation by a fuel cell in a low load condition and to then supply power from a power storage device.

2. Description of the Related Art

A fuel cell system of the related art, for example in Japanese Unexamined Application Publication No. 2007-165080, allows a fuel cell to generate power while inhibiting cooling water from being supplied to the fuel cell when the system is stopped, if the temperature of the fuel cell is expected to be at a predetermined temperature or lower when the system is restarted. A cooling water pump and a cooling fan are intermittently operated depending on a temperature of the fuel cell or the temperature of a catalyst layer in the fuel cell. The fuel cell system of the related art activates the cooling water pump and the cooling fan based on the temperature of the fuel cell or the temperature of the catalyst layer.

### SUMMARY OF THE INVENTION

In one embodiment, the present invention provides a fuel cell system having a fuel cell configured to operate in an operation mode selected from a power generation mode and a power generation stop mode and a coolant supply device for circulating a supply of coolant to a coolant path for cooling the fuel cell. A fuel cell temperature detector detects a fuel cell temperature of the fuel cell and a coolant temperature detector detects a coolant temperature of the coolant in the coolant path. A controller controls the amount of coolant circulated by the coolant supply device, selects the operation mode of the fuel cell between the power generation mode and the power generation stop mode, and calculates the difference between the detected coolant temperature and detected fuel cell temperature. While the operation mode of the fuel cell is selected to be the power generation stop mode the controller increases the amount of the coolant circulated as the difference between the detected coolant temperature and the detected fuel cell temperature increases.

In another embodiment, the present invention provides a fuel cell system having a fuel cell configured to operate in an operation mode selected from a power generation mode and a power generation stop mode and coolant supply means for circulating a supply of coolant though a coolant flow path for cooling the fuel cell. Fuel cell temperature detection means detects a fuel cell temperature of the fuel cell and coolant temperature detection means detects a coolant temperature of the coolant in the coolant path. Control means controls the amount of coolant circulated by the coolant supply means, selects the operation mode of the fuel cell between the power generation mode and the power generation stop mode, and calculates the difference between the detected coolant temperature and detected fuel cell temperature. While the operation mode of the fuel cell is selected to be the power generation stop mode, the amount of coolant circulated increases as the difference between the detected coolant temperature and the detected fuel cell temperature increases.

In another embodiment, the present invention provides a method for preventing thermal shock to a fuel cell in a fuel cell system. The method includes circulating an amount of coolant to cool the fuel cell, detecting a fuel cell temperature of the fuel cell, detecting a coolant temperature of the coolant, selecting an operation mode of the fuel cell to be one of a power generation mode and a power generation stop mode, and controlling the amount of coolant circulated to the fuel cell to increase as the difference between the detected coolant temperature and the detected fuel cell temperature increases when the power generation stop mode is selected.

Accordingly, when the operation mode is changed from the power generation stop mode to the power generation mode, and when the power generation is resumed, the fuel cell can be prevented from being deteriorated as a result of coolant flowing into the fuel cell when the coolant has a temperature markedly different from the temperature of the fuel cell.

### BRIEF DESCRIPTION OF THE DRAWINGS

The accompanying drawings, which are incorporated herein and constitute part of this specification, illustrate preferred embodiments of the invention, and together with the general description given above and the detailed description given below, serve to explain features of the invention.

FIG. 1 is a block diagram showing an example configuration of a fuel cell system to which the present invention is applied;

FIG. 2 is a block diagram showing an example configuration of a controller to which the present invention is applied;

FIG. 3 is a flowchart showing a first embodiment of the present invention;

FIGS. 4A to 4C are a control block diagram and graphs showing a calculation method according to the first embodiment of the present invention;

FIG. 5 is a flowchart showing a second embodiment of the present invention;

FIG. 6 is a graph showing a relationship between a fuel cell inlet/outlet temperature difference and a gas leak amount of the fuel cell;

FIG. 7 is a graph showing the change over time of a radiator cooling water temperature depending on an outside air temperature after a cooling water circulation pump is stopped;

FIG. 8 is a control block diagram showing a calculation method according to the second embodiment of the present invention;

FIG. 9 is a flowchart showing a third embodiment of the present invention;

FIG. 10 is a graph showing the change over time of a radiator cooling water temperature depending on a vehicle speed after the cooling water circulation pump is stopped;

FIG. 11 is a control block diagram showing a calculation method according to the third embodiment of the present invention;

FIG. 12 is a flowchart showing a fourth embodiment of the present invention; and

FIG. 13 is a flowchart showing a fifth embodiment of the present invention.

### DESCRIPTION OF THE PREFERRED EMBODIMENTS

Embodiments of the present invention will be described in detail below with reference to the accompanying drawings.

### First Embodiment

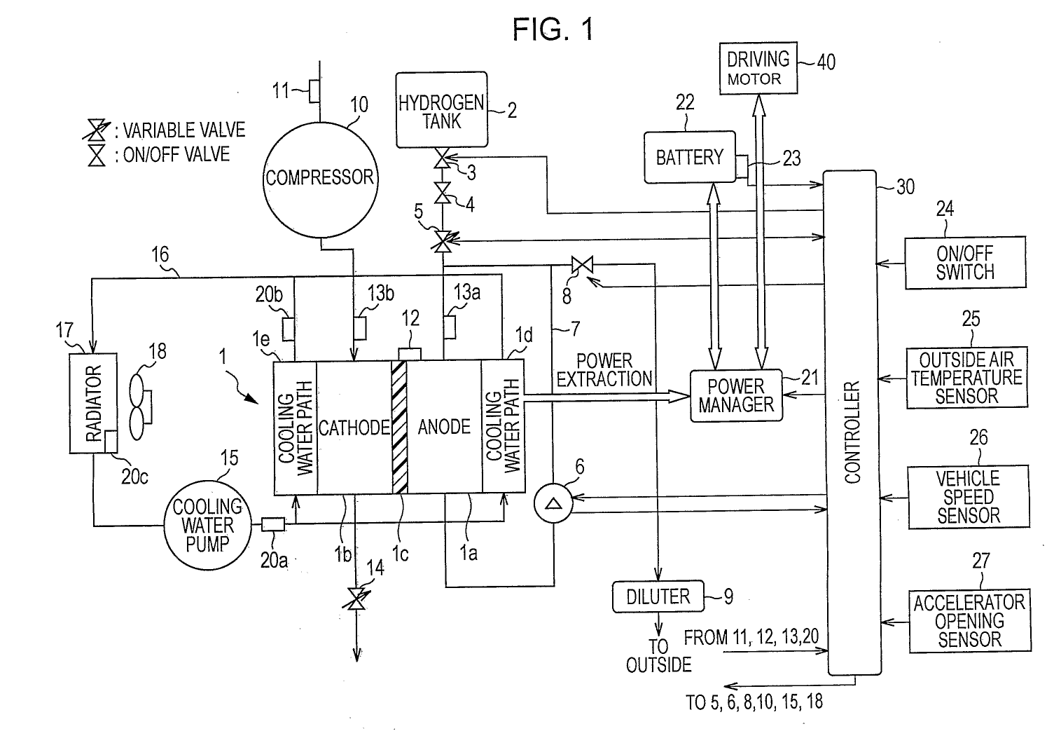

FIG. 1 is a system block diagram showing an overview of a fuel cell system to which the present invention is applied. For example, a fuel cell system mounted on a vehicle is illustrated. As shown, a fuel cell 1 is a solid polymer fuel cell, which includes an anode 1a, a cathode 1b, and an electrolyte membrane 1c interposed therebetween. The anode 1a is supplied with hydrogen gas, and the cathode 1b is supplied with air. Accordingly, electrode reaction progresses as described below, and power is generated based on the following chemical formulae.

Anode (hydrogen electrode): H₂→2H++2e⁻

Cathode (oxygen electrode): 2H⁺+2e-+½O₂→H₂O

Hydrogen is supplied to the anode 1a from a hydrogen tank 2 through a hydrogen tank master valve 3, a pressure reducing valve 4, and a hydrogen pressure regulating valve 5. The pressure reducing valve 4 mechanically reduces a pressure of high pressure hydrogen supplied from the hydrogen tank 2 to a predetermined pressure. A controller 30 controls the hydrogen pressure regulating valve 5 so that a hydrogen pressure at a fuel cell inlet becomes a desired hydrogen pressure. A pressure sensor 13a detects the hydrogen pressure at the fuel cell inlet, and transmits the detected hydrogen pressure to the controller 30. A hydrogen circulation pump 6 and a hydrogen circulation path 7 are provided to re-circulate hydrogen not consumed by the anode 1a. Since the air is supplied as an oxidizer to the cathode 1b, nitrogen, which causes no chemical reaction, passes through the electrolyte membrane 1c and is accumulated in a hydrogen circulation path 7. If the accumulated amount of nitrogen becomes excessive, the hydrogen partial pressure decreases, and circulating performance of the hydrogen circulation pump 6 is degraded, resulting in stable power generation being no longer provided. Because of this, the controller 30 estimates the accumulated amount of nitrogen, and when the accumulated amount of nitrogen exceeds a threshold value, the controller 30 opens a purge valve 8 to discharge the nitrogen to the outside of the vehicle.

A diluter 9 mixes the hydrogen with the air to dilute the hydrogen, which is discharged by the purge valve 8 simultaneously when the nitrogen is discharged, so that the discharged gas has a density lower than a density of the flammability limit before the discharge to the outside.

An oxidizing gas compressor 10 compresses the air to be supplied to the cathode 1b. A flow sensor 11 is provided at a compressor inlet, and detects a mass flow of the air. An air pressure regulating valve 14 is provided at a cathode outlet, and regulates a cathode back pressure. A pressure sensor 13b detects an air pressure of the cathode 1b. The controller 30 controls the cathode pressure by controlling an opening of the air pressure regulating valve 14 based on a detection value of the pressure sensor 13b. The compressor 10 transmits power to be consumed by the compressor 10 to the controller 30.

The fuel cell 1 also includes at least one coolant path for control of the operation temperature of the fuel cell 1. As depicted, the fuel cell 1 includes two cooling water paths 1d and 1e for control of the operation temperature. The coolant paths 1d and 1e are connected to a radiator (heat exchanger) 17 via a coolant circulation path 16. In one implementation, the coolant is cooling water. A cooling water pump (coolant supply device) 15 causes cooling water to be circulated. The radiator 17 is typically arranged in a front portion of the vehicle. The radiator 17 uses air flow produced by traveling of the vehicle to cool the cooling water.

The controller 30 adjusts a cooling water temperature based on detection values of either or both of a fuel cell inlet temperature sensor 20a and a fuel cell outlet temperature sensor 20b (collectively, the two sensors may be referred to as a fuel cell temperature detection unit), and accordingly driving the cooling water pump 15 and a radiator fan 18.

A power manager 21 (power extraction unit) extracts power from the fuel cell 1 and supplies the power to a driving motor 40 that drives the vehicle. The power is in the form of electrical current at a voltage generated by the fuel cell 1. The power manager 21 has a function of measuring current extracted from the fuel cell 1 for power extraction control. A voltage sensor 12 measures a fuel cell voltage of every cell, or a fuel cell voltage of every cell group in which a plurality of cells are connected in series, of the fuel cell 1. The controller 30 controls respective actuators in the system by using sensor signals to activate and stop the system, and to generate power in the system.

A power storage unit, such as a battery 22, is charged and discharged in the following situations: (a) when the battery 22 supplies power required for driving auxiliaries which are necessary for generating power in the fuel cell system; (b) when power generated by the fuel cell is deficient compared with the power required by the fuel cell system, power is supplied by the battery 22 in an amount of deficiency; (c) when power generated by the fuel cell exceeds the required power, the excess power is stored in the battery 22; and (c) when the battery 22 is charged by regenerated power from the driving motor, e.g., during deceleration or braking of the vehicle.

The power manager 21 transmits power to be consumed by the driving motor 40 to the controller 30. A battery controller 23 monitors certain battery information, including the voltage, the current, and the temperature of the battery 22. Also, the battery controller 23 transmits power accumulated in the battery 22 and power available for supply from the fuel cell 1, to the controller 30. A vehicle speed sensor 26 detects vehicle speed based on, for example, a wheel speed of the vehicle, or a rotational speed of the driving motor 40. An accelerator opening sensor 27 detects a degree of actuation of an accelerator pedal operated by a driver of the vehicle. An outside air temperature sensor 25 (ambient temperature detection unit) measures an ambient temperature of the radiator 17, i.e., the temperature of outside (ambient) air available for cooling the radiator 17. A cooling water temperature sensor 20c measures a cooling water temperature in the radiator 17.

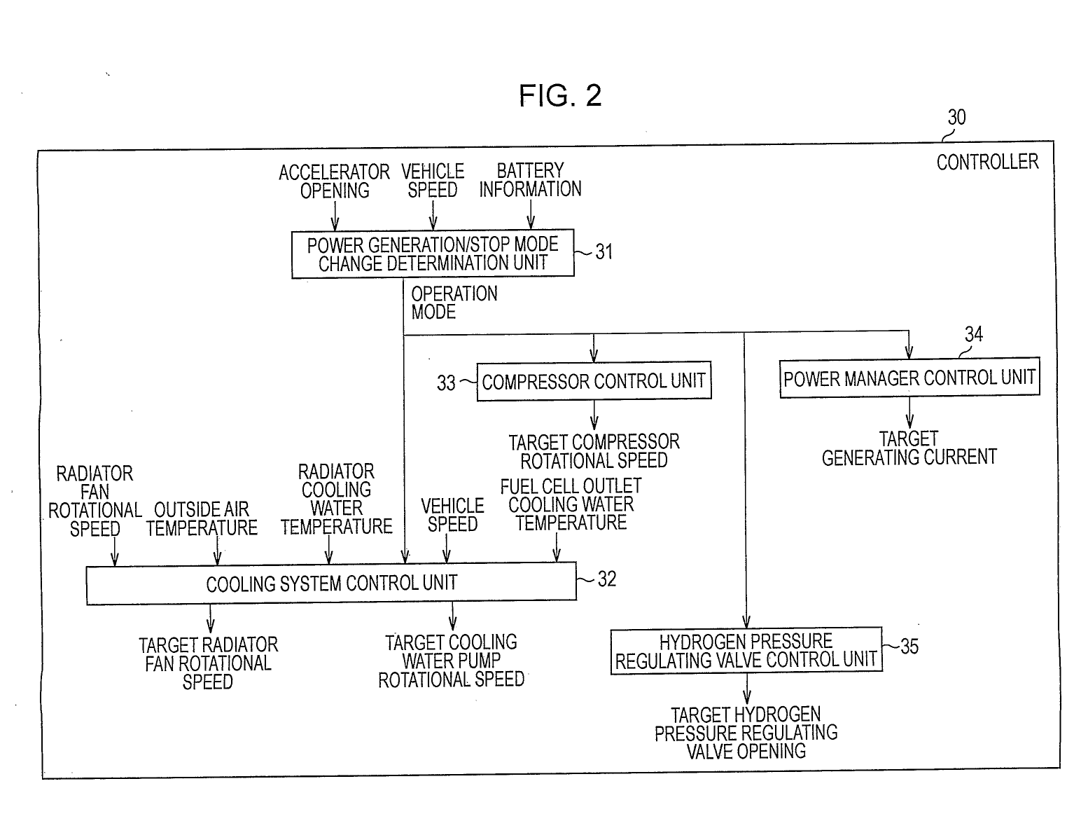

FIG. 2 illustrates a configuration of the controller 30 when the present invention is implemented. The controller 30 includes a power generation/stop mode change determination unit 31, a cooling system control unit 32, a compressor control unit 33, a power manager control unit 34, and a hydrogen pressure regulating valve control unit 35. The controller 30 performs several functions, including changing the operation mode of the fuel cell, controlling the cooling of the fuel cell, and predicting the coolant temperature. The power generation/stop mode change determination unit 31 determines change of the fuel cell system operation mode between a power generation mode for normal power generation and a power generation stop mode to stop power generation. The cooling system control unit 32, the compressor control unit 33, the power manager control unit 34, and the hydrogen pressure regulating valve control unit 35 control corresponding parameters depending on the operation mode, either the power generation mode or the power generation stop mode, as determined by the power generation/stop mode change determination unit 31.

The power generation/stop mode change determination unit 31 determines the operation mode, either the power generation mode or the power generation stop mode, based on parameters including, but not limited to, a vehicle speed signal from the vehicle speed sensor 26, an accelerator opening signal from the accelerator opening sensor 27, and battery information from the battery controller 23. Then, the power generation/stop mode change determination unit 31 indicates either the power generation mode or the power generation stop mode as the selected operation mode.

For example, the operation mode is determined to be the power generation stop mode when one or more of the following conditions occur: the vehicle speed is at a predetermined speed or lower (including a stop state), the accelerator opening is at a predetermined opening or smaller (including an accelerator off state), the battery state of charge corresponds to a predetermined level or higher, and the battery 22 is in a discharge-available state. Otherwise, the operation mode is determined to be the power generation mode as long as warming-up of the fuel cell system has been completed.

The predetermined speed, the predetermined opening, and the predetermined power are appropriately determined based on, for example, the weight of a vehicle, the characteristics of the vehicle within which the fuel cell system mounted, the maximum capacity of a battery, and the maximum discharge performance of the battery.

In the power generation mode, the fuel cell 1 supplies the required power for the driving motor 40 and the required power for operating the fuel cell system depending on the vehicle speed and the accelerator opening. However, if the output of the fuel cell 1 is transiently deficient, power by an amount of the deficiency may be supplied from the battery 22. If the power output generated by the fuel cell 1 is more than required in the power generation mode, the excess power may be used to charge the battery 22.

In the power generation mode, the compressor 10 is operated to supply air to the cathode 1b of the fuel cell 1. Also, in the power generation mode, the hydrogen pressure regulating valve 5 allows hydrogen to be supplied to the anode 1a of the fuel cell 1, and the hydrogen circulation pump 6 is driven. Further, in the power generation mode, the cooling water pump 15 and the radiator fan 18 are driven according to the temperature sensors 20a, 20b, and 20c of the cooling water, and the temperature of the fuel cell 1 is maintained at a temperature suitable for fuel cell operation.

In the power generation stop mode, power generation by the fuel cell 1 is stopped, and the required power for operating the fuel cell system is supplied from the battery 22. In the power generation stop mode, the driving of the compressor 10 and the driving of the hydrogen circulation pump 6 are stopped. Also, in the power generation stop mode, the cooling water pump 15 (described later) can be driven in order to control the cooling water temperature, which is a feature of the embodiment of the present invention.

The compressor control unit 33 operates the compressor 10 when the operation mode is the power generation mode, and stops the compressor 10 when the operation mode is the power generation stop mode.

The power manager control unit 34 allows the power manager 21 to extract current from the fuel cell 1 when the operation mode is the power generation mode, and inhibits the power manager 21 from performing current extraction from the fuel cell 1 when the operation mode is the power generation stop mode.

The hydrogen pressure regulating valve control unit 35 controls the opening of the hydrogen pressure regulating valve 5 to provide the hydrogen supply when the operation mode is the power generation mode, and controls the opening of the hydrogen pressure regulating valve 5 to block the hydrogen supply when the operation mode is the power generation stop mode.

The cooling system control unit 32 determines a target radiator fan rotational speed and a target cooling water pump rotational speed (i.e., a required cooling water supply flow rate) based on the operation mode determined by the power generation/stop mode change determination unit 31, the radiator fan rotational speed, the outside air temperature, the vehicle speed, and the cooling water outlet temperature.

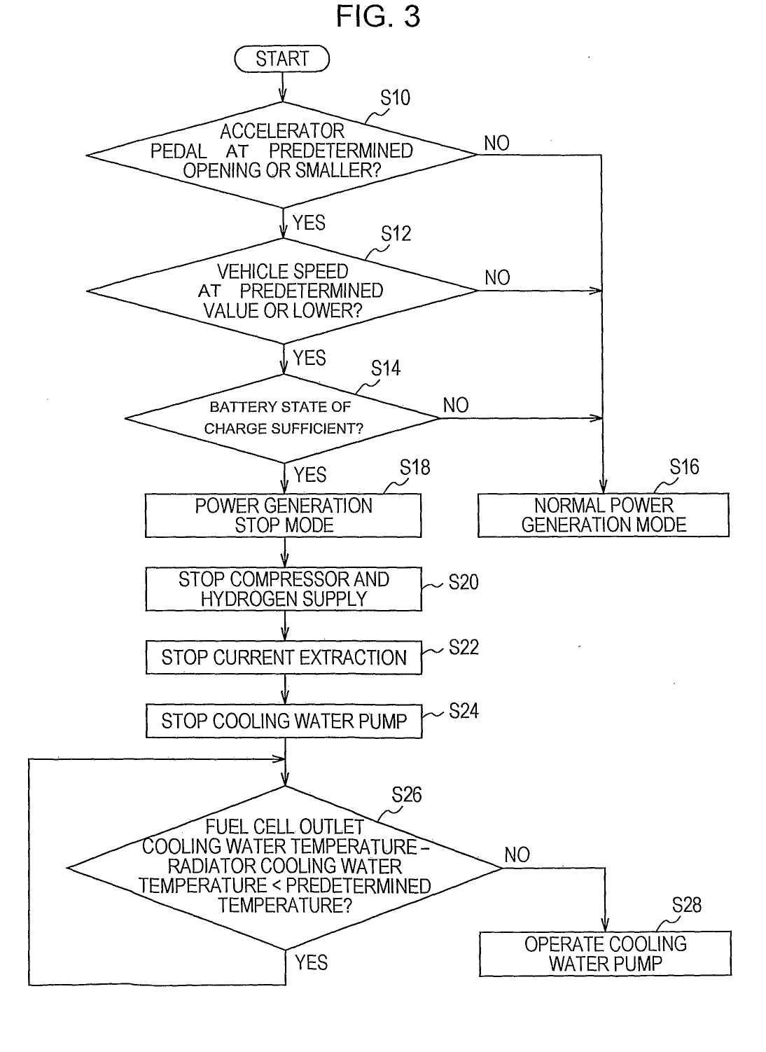

FIG. 3 is a flowchart showing a control process of the controller 30 according to the first embodiment. The process depicted in the flowchart is called at predetermined intervals and is performed while the fuel cell system is operating in the power generation mode. In describing the process, steps are designated as “S” followed by the step number. In step S10, the power generation/stop mode change determination unit 31 reads a detection value of the accelerator opening sensor 27 and determines whether or not the accelerator opening (typically, but not necessarily, based on the position of the accelerator pedal) is at the predetermined opening amount or smaller. If the accelerator opening is at the predetermined opening or smaller, the process goes to step S12. If the accelerator opening is not at the predetermined opening or smaller, the power generation mode in step S16 continues to be selected. In step S12, a detection value of the vehicle speed sensor 26 is read, and it is determined whether or not the vehicle speed is at a predetermined speed (for example, 20 km/h) or lower. If the vehicle speed is at the predetermined speed or lower, the process goes to step S14. If the vehicle speed is not at the predetermined speed or lower, the power generation mode in step S16 continues to be selected.

Then, in step S14, a remaining battery state of charge is read from the battery controller 23, and it is determined whether or not the remaining battery state of charge is at a predetermined state of charge or greater. The predetermined state of charge indicates a stored energy amount necessary to enable the fuel cell 1 to be continuously stopped from generating power for a specified time, for example one minute or longer. If the remaining battery state of charge is not at the predetermined state of charge or greater, the power generation mode in step S16 is continues to be selected. If the remaining battery state of charge is at the predetermined state of charge or greater, the process goes to step S18. In step S18, it is determined that the power generation can be stopped. The power generation/stop mode change determination unit 31 outputs the power generation stop mode as the operation mode to the cooling system control unit 32, the compressor control unit 33, the power manager control unit 34, and the hydrogen pressure regulating valve control unit 35.

In step S20, after the selection of the power generation stop mode, the compressor control unit 33 stops the operation of the compressor so that the air supply to the fuel cell is stopped, and the hydrogen pressure regulating valve control unit 35 closes the hydrogen pressure regulating valve so that the hydrogen supply to the fuel cell is stopped.

In step S22, after the selection of the power generation stop mode in step S18 and the stop of reaction gas supply to the fuel cell 1 in step S20, the power manager control unit 34 stops the current extraction from the fuel cell 1. Then, the process goes to step S24.

In step S24, after the stop of the current extraction from the fuel cell 1 in step S22 and the stop of heating the fuel cell 1, the cooling system control unit 32 stops the operation of the cooling water pump 15, or reduces the rotational speed of the cooling water pump 15 to provide a cooling water flow rate that is less than a cooling water flow rate during the normal operation (i.e., the cooling water flow rate during the power generation mode operation of the fuel cell). Then, in step S26, the cooling system control unit 32 calculates the difference between a fuel cell outlet cooling water temperature from the temperature sensor 20b (or a fuel cell inlet cooling water temperature from the temperature sensor 20a) and a radiator cooling water temperature from the temperature sensor 20c, and determines whether or not the difference is smaller than a predetermined value. If the temperature difference is at the predetermined value or greater, the process goes to step S28, in which the cooling water pump 15 is operated such that a coolant supply amount increases as the temperature difference increases, even while the power generation is stopped, that is, when the operation mode is the power generation stop mode. If the temperature difference is smaller than the predetermined value in step S26, the calculation of the temperature difference and the determination of the difference in step S26 are repeated while the operation of the cooling water pump 15 continues to be stopped.

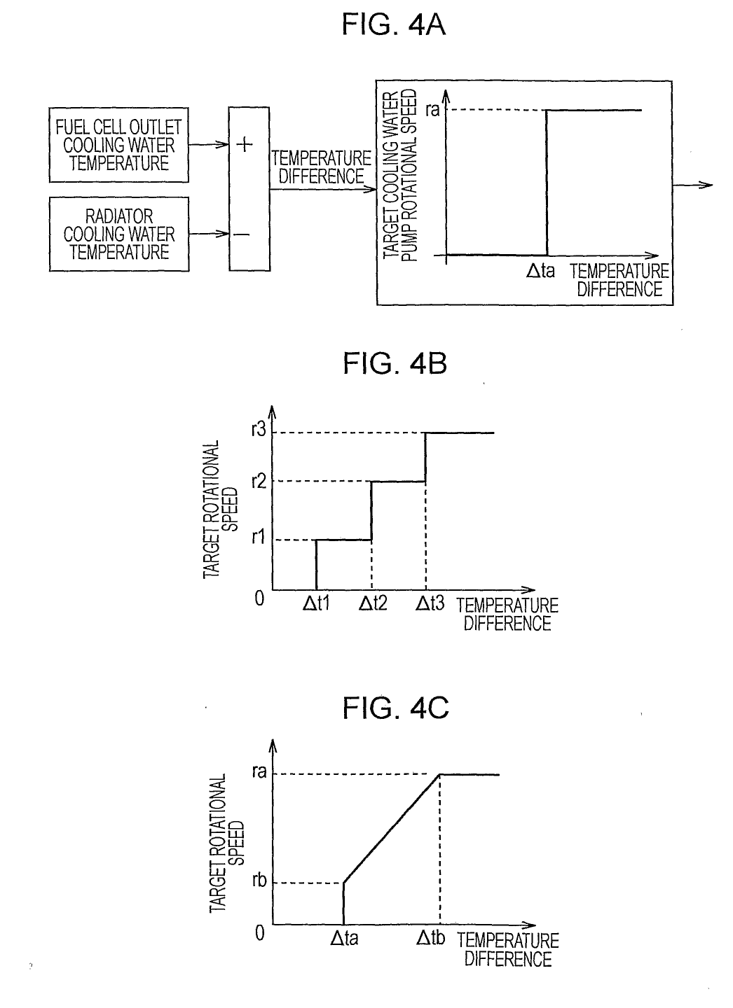

FIG. 4A is a control block diagram showing a control routine implemented in step S26 and step S28. The temperature difference Δt, which is the difference between the fuel cell outlet cooling water temperature and the radiator cooling water temperature, is obtained, and based on the temperature difference, the operation condition (rotational speed) of the cooling water pump is controlled such that the coolant supply amount increases as the temperature difference increases. In particular, for example, a control map is retrieved, and a target cooling water pump rotational speed is calculated based on the difference between the fuel cell outlet cooling water temperature and the radiator cooling water temperature. Referring to FIG. 4A, the control map may be arranged such that the target cooling water pump rotational speed is at a rotational speed ra during operation in the power generation stop mode if the temperature difference is a predetermined temperature difference Δta or greater, and such that the target cooling water pump rotational speed is zero and the cooling water pump is stopped if the temperature difference is smaller than the predetermined temperature difference Δta.

Alternatively, the cooling water pump 15 may be controlled by smaller steps rather than the simple ON/OFF control. For example, referring to FIG. 4B, the cooling water pump may be stopped if the temperature difference Δt is smaller than Δt1, the target rotational speed of the cooling water pump may be r1 if the temperature difference is Δt1 or greater and smaller than Δt2, the target rotational speed of the cooling water pump may be r2 if the temperature difference is Δt2 or greater and smaller than Δt3, and the target rotational speed of the cooling water pump may be r3 if the temperature difference is Δt3 or greater. Herein, it is assumed that Δt1<Δt2<Δt3, and r1<r2<r3.

Still alternatively, referring to FIG. 4C, the target rotational speed may be continuously changed in accordance with the temperature difference. In this example, the target cooling water pump rotational speed may be zero and the cooling water pump may be stopped if the temperature difference is smaller than a temperature difference Δta, the target cooling water pump rotational speed may be r varied linearly if the temperature difference is greater than or equal to a temperature difference Δta and less than or equal to a temperature difference Δtb (wherein Δta<Δtb), and the target cooling water pump rotational speed may be ra (constant) if the temperature difference is the temperature difference Δtb or greater. The linear region of the curve in FIG. 4C can be described by the following equation.

r=rb+(ra−rb)(Δtb−Δt)/(Δtb−Δta)

As described above, in this embodiment, the mode change unit changes the operation mode between the power generation mode, in which the power generated by the fuel cell is supplied to the vehicle, and the power generation stop mode, in which the power generation by the fuel cell is stopped and the power is supplied to the vehicle from the battery; the operation mode is changed depending on the speed of the vehicle, the acceleration operation amount, and the condition (including the state of charge) of the power storage unit (battery). As used herein, the term “vehicle” includes any transportation device which can be adapted to operate using electricity as a power source. For example, a vehicle includes, but is not limited to, an automobile, a truck, a bus, a train, a trolley, a boat, a scooter, and a motorcycle.

Also, when the mode change unit changes the operation mode from the power generation mode to the power generation stop mode, the coolant supply device which is controlled by the cooling control unit 32 decreases the supply of coolant as the difference between the detected or predicted coolant temperature in the heat exchanger and the detected or predicted fuel cell temperature decreases. (Note that although the present embodiment does not compute or utilize a predicted coolant temperature, other embodiments disclosed herein do.)

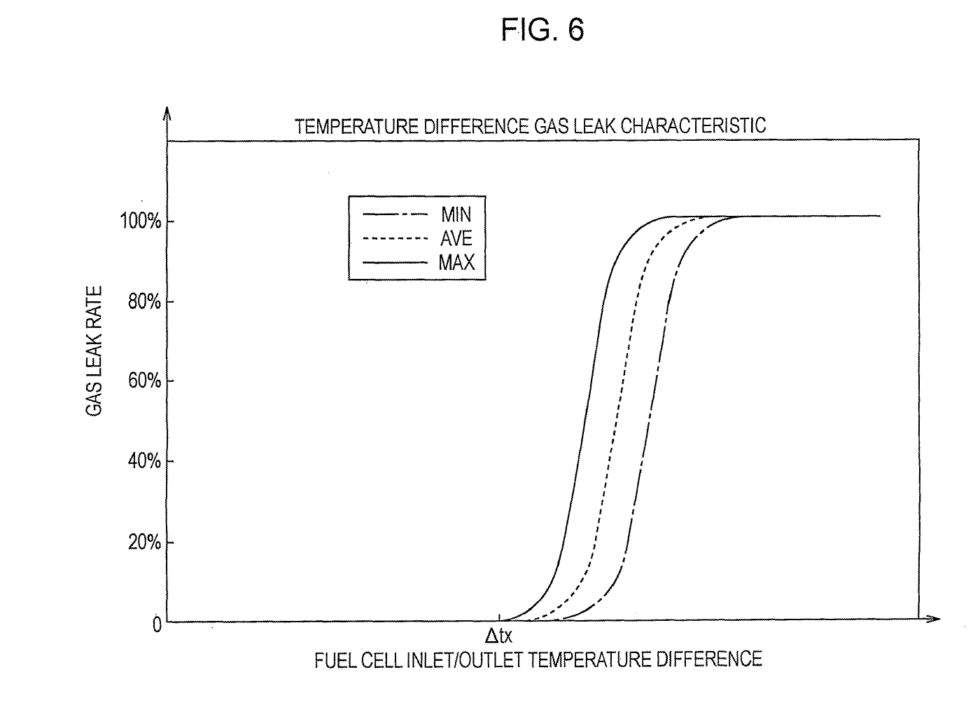

Accordingly, even in the power generation stop mode, the difference between the cooling water temperature in the radiator and the cooling water temperature in the fuel cell can be maintained to be relatively small. Thus, when the operation mode is recovered or restarted from the power generation stop mode to the power generation mode, the fuel cell system will not encounter a situation in which cooling water in the radiator having a temperature that is markedly lower than the fuel cell temperature flows into the fuel cell and potentially causes damage to the fuel cell. By preventing such a temperature difference from being generated in the cooling water path of the fuel cell, the fuel cell can be prevented from being deteriorated due to a thermal shock from cooling water that is significantly cooler than the fuel cell itself. As a result, fuel gas can be prevented from leaking from the fuel cell (a condition often caused by thermal shock, as described below in reference to FIG. 6) and fuel efficiency of the fuel cell can be prevented from decreasing.

### Second Embodiment

Next, a fuel cell system according to a second embodiment of the present invention is described. In the second embodiment, the cooling water temperature sensor 20c is not used. This embodiment employs a method of predicting the cooling water temperature in the radiator 17 using a detection value of the outside air temperature sensor 25 which detects the ambient temperature in the radiator, instead of using the cooling water temperature sensor 20c which detects the cooling water temperature in the radiator 17. The general configuration of the fuel cell system is similar to that of the first embodiment shown in FIG. 1 except that the cooling water temperature sensor 20c is not necessary. Also, the configuration of the controller 30 is similar to the example configuration of the first embodiment shown in FIG. 2 except that a predicted value of the radiator cooling water temperature is used instead of the actual radiator cooling water temperature.

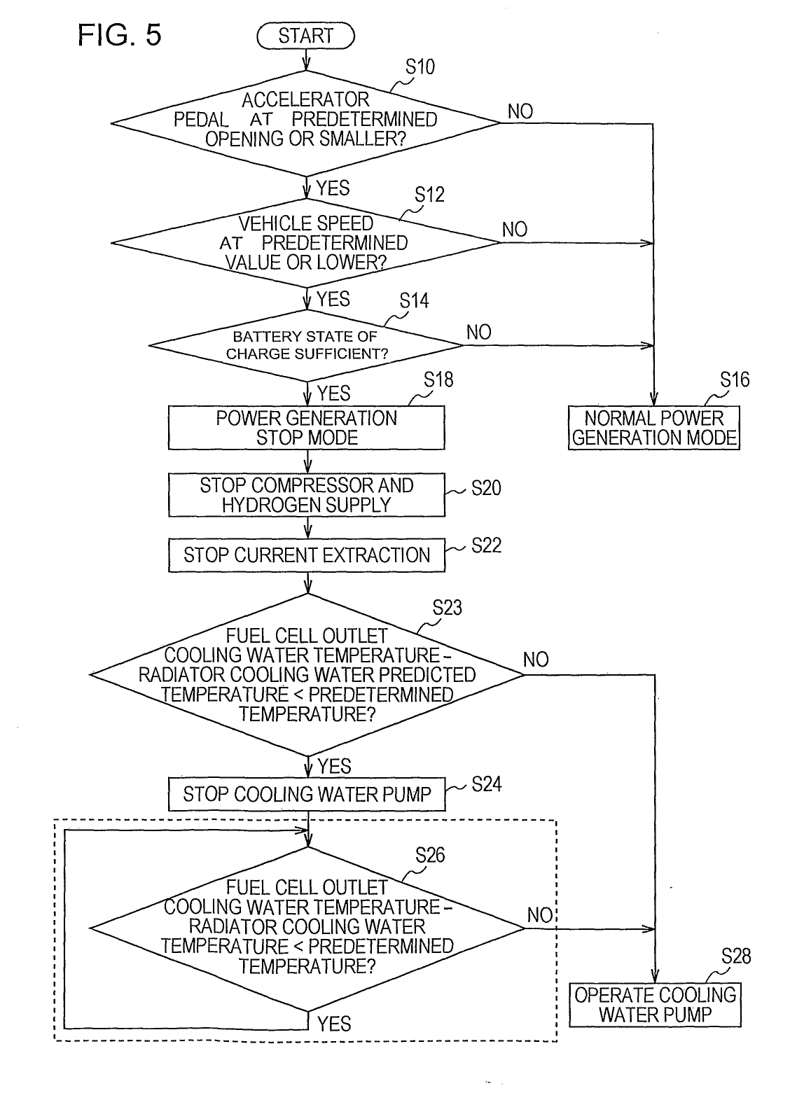

FIG. 5 is a flowchart showing a control process of the controller 30 according to the second embodiment. FIG. 5 is different from the flowchart of the first embodiment shown in FIG. 3 in that step S23 is added.

In step S23, the predicted value of the radiator cooling water temperature after a predetermined time elapses is calculated, and it is determined whether or not the difference between the predicted value of the radiator cooling water temperature and the fuel cell outlet cooling water temperature (or fuel cell inlet cooling water temperature) immediately after the power generation is stopped is at a predetermined temperature difference or smaller.

Herein, the predetermined temperature difference is an inlet/outlet temperature difference Δtx immediately before a gas leak rate from a sealing surface of the fuel cell starts to increase as shown in FIG. 6. If the calculation result of the temperature difference is smaller than the predetermined temperature difference Δtx, the process goes to step S24, in which the cooling water pump is stopped. If the calculation result of the temperature difference is the predetermined temperature difference Δtx or greater, the process goes to step S28, in which the cooling water pump is continuously operated.

The radiator (heat exchanger) 17 which dissipates an amount of heat from the cooling water is located at a position more likely to be affected by the outside environment, as compared with the position of the fuel cell 1. In addition, the radiator 17 is designed and manufactured so as to have a smaller heat resistance between the cooling water in the radiator 17 and the outside (ambient) air, as compared with the fuel cell 1. Hence, after the power generation is stopped and the circulation of the cooling water is stopped, the temperature of the cooling water in the radiator 17 decreases faster than the temperature of the cooling water in the fuel cell 1. Thus, if the cooling water supply is resumed merely in accordance with the fuel cell temperature as in the related art, low temperature cooling water is supplied from the radiator 17 to the fuel cell 1, resulting in a large temperature difference being generated in the fuel cell cooling water path.

FIG. 6 is a graph showing an example of the gas leak rate with respect to the fuel cell inlet/outlet temperature difference. The solid line designated “max” in the drawing indicates a maximum gas leak rate, the broken line designated “ave” indicates an average gas leak rate, and the dotted-chain line designated “min” indicates a minimum gas leak rate observed in experiments. All rates are based on a maximum gas leakage amount. The maximum gas leak rate plots an S-shaped curve, in which the gas leak rate starts to increase when the fuel cell inlet/outlet temperature difference is Δtx, linearly increases in a range of the gas leak rate from about 15% to about 85%, and thereafter does not increase although the temperature difference increases. Each of the maximum gas leak rate, the average gas leak rate, and the minimum gas leak rate increases as the temperature difference increases. The leakage of fuel gas that is thus not to be used for power generation may cause the fuel efficiency of the fuel cell to decrease. Therefore, it is desirable to prevent a large Δtx in order to minimize gas leakage and thus avoid a loss of efficiency.

Also, the radiator 17 is affected by the ambient air temperature and by the air volume that can be flowed across the radiator 17. Hence, if the predicted temperature of the coolant is determined merely by the condition while the power generation is stopped, a prediction error of the coolant temperature becomes noticeable.

In addition, if the radiator is mounted on the vehicle, the radiator may be cooled by using wind produced by traveling of the vehicle. In many cases, the radiator fan (cooling fan) which provides the air to the radiator is shared by an air-conditioning system for a cabin of the vehicle. When only the radiator fan is controlled, it is difficult to prevent excessive cooling of the coolant.

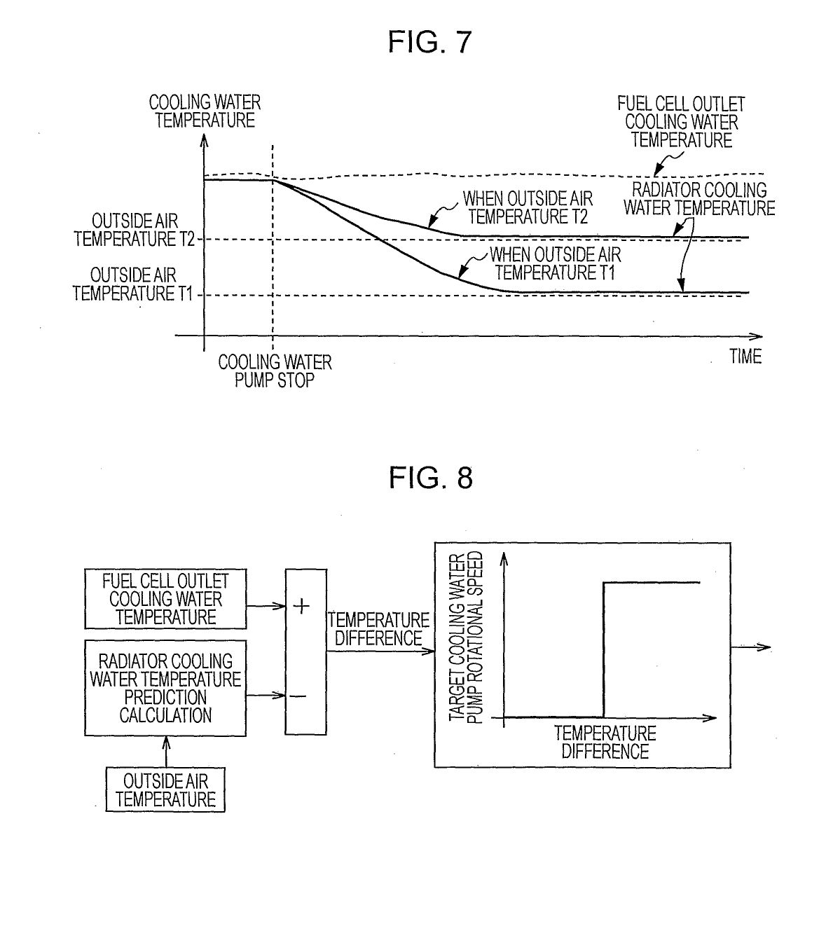

FIG. 7 is a graph showing the change over time of the cooling water temperature after current extraction from the fuel cell 1 is stopped and the cooling water pump 15 is stopped. When current extraction from the fuel cell 1 is stopped, heat generation in the fuel cell is stopped. When the cooling water pump is stopped, the cooling water temperature in the fuel cell gradually decreases, and by comparison, the cooling water temperature in the radiator relatively rapidly decreases toward the outside air temperature. After an extended period of time, the cooling water temperature of the radiator becomes approximately equal to the outside air temperature.

Next, referring to a control block diagram in FIG. 8, the control of the cooling water pump 15 is described. The cooling water pump 15 is controlled based on the difference between the fuel cell outlet cooling water temperature and a predicted value of the radiator cooling water temperature in step S23, step S24, and step S28 according to this embodiment.

First, a detection value of the outside (ambient) air temperature sensor 25 is read, and the radiator cooling water temperature is predicted based on the radiator ambient air temperature detected by the outside air temperature sensor 25. Then, a detection value of the fuel cell outlet temperature sensor 20b is read, and the difference between the fuel cell outlet cooling water temperature and the predicted value of the radiator cooling water temperature is obtained. Then, using the calculated temperature difference, the cooling water pump 15 is controlled such that the operation condition (rotational speed) of the cooling water pump 15 is enhanced (i.e., the rotational speed of the pump is increased) as the temperature difference increases.

In particular, for example, a control map is retrieved, and a target cooling water pump rotational speed is calculated based on the difference between the fuel cell outlet cooling water temperature and the radiator cooling water temperature. Referring to FIG. 8, the control map may be arranged such that the target cooling water pump rotational speed is a rotational speed during the normal power generation (i.e., during power generation mode operation of the fuel cell 1) if the temperature difference is a predetermined temperature difference or greater, and such that the target cooling water pump rotational speed is zero and the cooling water pump 15 is stopped if the temperature difference is smaller than the predetermined temperature difference.

Alternatively, for example, the control shown in FIG. 4B or 4C may be performed similarly to the first embodiment.

For a vehicle such as an automobile, a truck, or a bus, the outside air temperature sensor 25 and the radiator 17 are typically arranged in an enclosed space such as under the vehicle hood. Thus, when the vehicle is stopped after traveling, heat is accumulated under the hood. Hence, the outside air temperature sensor 25 may detect a temperature higher than an actual radiator ambient air temperature. Because of this, by using the outside air temperature detected during traveling, prediction accuracy can be increased.

Also, in the second embodiment, step S26 (surrounded by a broken line in FIG. 5) may be additionally performed similarly to step 26 in the first embodiment.

The above-described second embodiment includes the outside air temperature sensor (ambient temperature detection unit) 25 which detects the ambient temperature of the radiator (heat exchanger) 17, and the coolant temperature prediction unit which predicts the cooling water (coolant) temperature based on the ambient temperature detected by the outside air temperature sensor 25. Accordingly, the radiator cooling water temperature can be predicted without a temperature sensor provided in the radiator 17. In particular, in the automobile, the outside air temperature sensor 25 is typically mounted for air-conditioning control. By using the outside air temperature sensor, the cooling water temperature can be predicted with no component additionally provided.

Also, when the mode change determination unit 31 changes the operation mode from the normal power generation mode to the power generation stop mode, the coolant supply device 15 which is controlled by the cooling control unit 32 decreases supply of coolant as the difference between the predicted coolant temperature in the heat exchanger 17 and the fuel cell temperature decreases. Accordingly, even in the power generation stop mode, the difference between the cooling water temperature in the radiator 17 and the cooling water temperature in the fuel cell 1 can be maintained to be small. Thus, when the operation mode is recovered or restarted from the power generation stop mode to the power generation mode, a situation is avoided wherein the cooling water in the radiator has a temperature which is markedly lower than the fuel cell temperature, so that a large temperature difference does not occur between the cooling water and the fuel cell in the cooling water path of the fuel cell.

Therefore, the fuel cell can be prevented from being deteriorated due to a thermal shock, the fuel gas can be prevented from leaking due to the temperature difference (or gas leakage can be minimized), and the fuel efficiency of the fuel cell can be prevented from decreasing.

### Third Embodiment

Next, a fuel cell system according to a third embodiment of the present invention is described. In the third embodiment, the cooling water temperature sensor 20c is not used, similarly to the second embodiment.

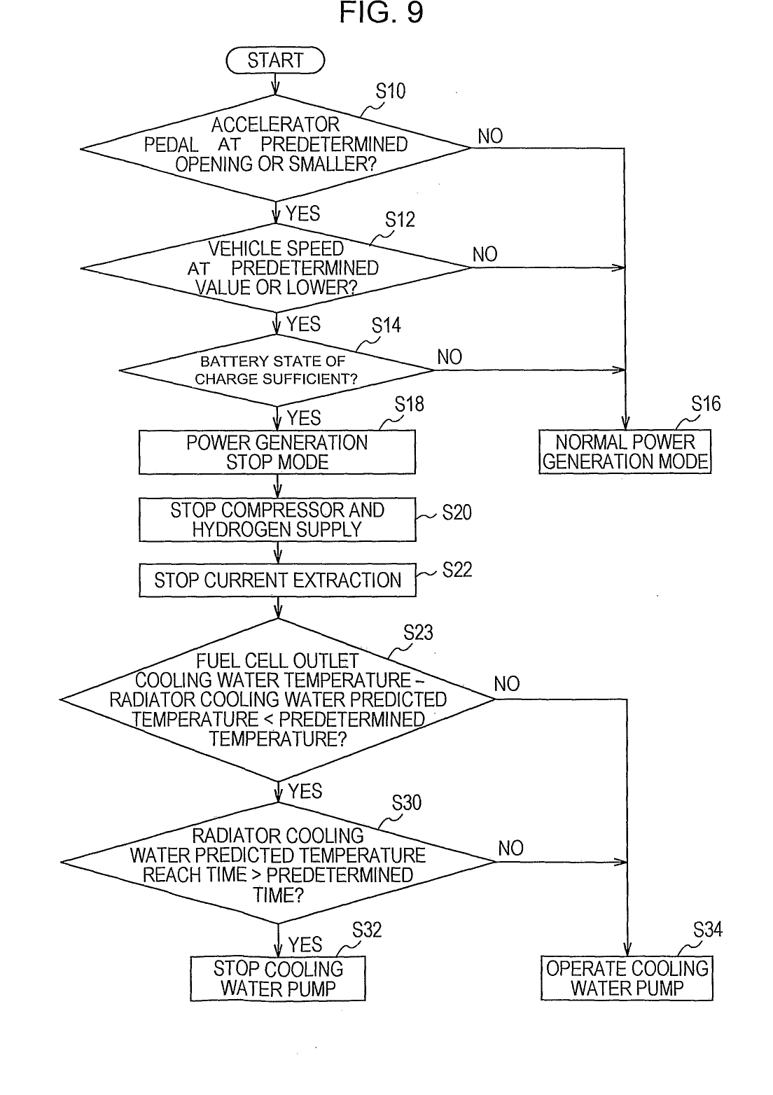

FIG. 9 is a flowchart showing a control process of the controller 30 according to the third embodiment. In FIG. 9, steps S10 through S22 are similar to the corresponding process steps of the second embodiment.

In step S23, a predicted value of the radiator cooling water temperature is calculated. This step is different from step S23 of the second embodiment in that, in step S23 of the third embodiment, a predicted value of the radiator cooling water temperature is calculated based on the outside air temperature and the vehicle speed.

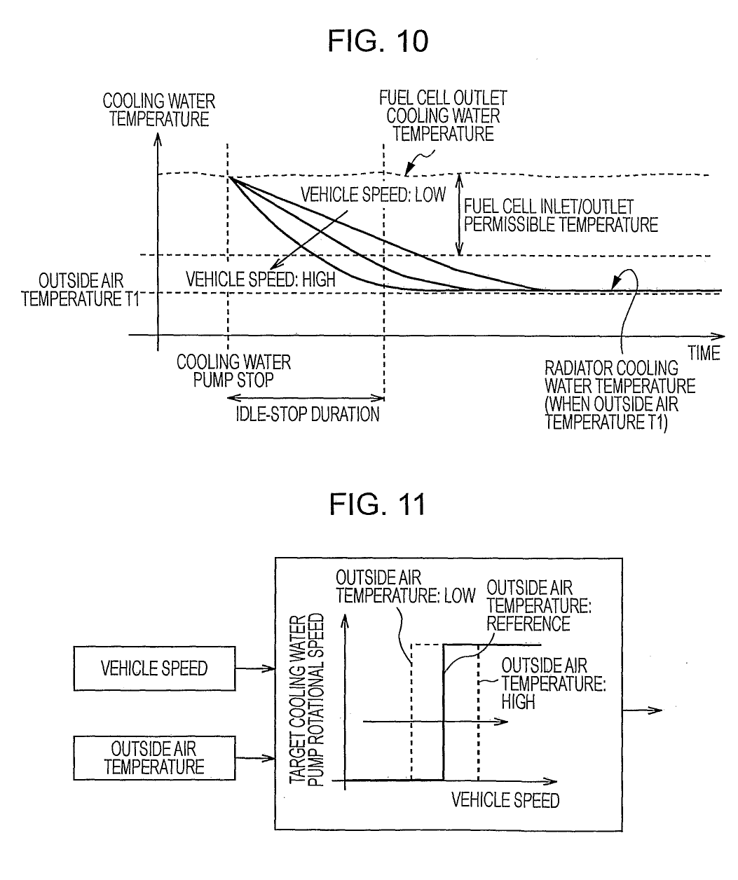

Referring to FIG. 10, a change in radiator cooling water temperature after the power generation when the fuel cell is stopped and the cooling water pump is stopped varies depending on the vehicle speed, even at the same outside air temperature T1. As vehicle speed increases, the amount of heat dissipated by the radiator 17 increases and hence the radiator cooling water temperature typically decreases more quickly toward the ambient air temperature than when the vehicle is stationary. Data shown in FIG. 10 was acquired through experiments with actual equipment and through thermal analysis. Also, the decrease in radiator cooling water temperature is predicted based on vehicle speed during a time period (for example, 5 minutes) in which the fuel cell is in the power generation stop mode. Then, the cooling water pump is controlled not to be stopped if the difference between the fuel cell outlet temperature and the predicted radiator cooling water temperature exceeds a permissible value.

A maximum time during which the power generation is continuously stopped (idle-stop duration) may be calculated from the state of charge of the battery. Hence, using the maximum stop time, a method may be employed to calculate whether or not the cooling water temperature decreases below the fuel cell outlet temperature by greater than a predetermined value within that time. When the time in which the power generation is continuously stopped is calculated based on the battery state of charge, the time is obtained by dividing a dischargeable power (or dischargeable charge amount) of the battery by a total power consumption (or current consumption) in the fuel cell system and the vehicle.

In step S23, after the predicted value of the radiator cooling water temperature is calculated, the difference between the predicted value and the fuel cell outlet cooling water temperature (or the fuel cell inlet cooling water temperature) immediately after the power generation is stopped is calculated. Then, the calculation result of the temperature difference is compared with the predetermined temperature difference Δtx. The predicted temperature difference Δtx can be the inlet/outlet temperature difference shown in FIG. 6 immediately before the gas leak rate starts to increase, indicating a loss of efficiency due to the gas leaking from the sealing surface of the fuel cell.

If it is determined in step S23 that the difference between the fuel cell outlet cooling water temperature and the radiator cooling water predicted temperature is smaller than a predetermined temperature difference, the process goes to step S30. If the difference between the fuel cell outlet cooling water temperature and the radiator cooling water predicted temperature is the predetermined temperature difference or greater, the process goes to step S34, in which the operation of the cooling water pump 15 is continued.

In step S30, a predicted value of the time it takes for the radiator cooling water temperature to decrease to a predetermined temperature is calculated, and it is determined whether or not the predicted value exceeds a predetermined time (idle-stop duration). If the predicted value exceeds the predetermined time, as determined in step S30, the decrement of the radiator cooling water temperature is small, and thus, the process goes to step S32, in which the cooling water pump 15 is stopped. If the predicted value, or the time it takes for the radiator cooling water temperature to decrease to the predetermined temperature is the predetermined time or shorter, as determined in step S30, the process goes to step S34, in which the operation of the cooling water pump 15 is continued.

FIG. 11 is a control block diagram showing a determination and control process in steps S30 through S34. A control map is retrieved, and a target cooling water pump rotational speed is obtained, based on a vehicle speed read from the vehicle speed sensor 26, and the outside air temperature (ambient temperature of the radiator 17) read from the outside air temperature sensor 25. The control map is arranged such that the cooling water pump is operated if the vehicle speed is equal to or higher than a determination speed value, and such that the cooling water pump is stopped if the vehicle speed is lower than the determination speed value. The determination speed value increases as the outside air temperature increases, and decreases as the outside air temperature decreases. The control map may be previously acquired experimentally with actual equipment, or it may be obtained by a heat flow calculation using heat models of the fuel cell and the radiator.

While it is determined whether the cooling water pump is operated or stopped based on the vehicle speed and the outside air temperature in the third embodiment, a correction may additionally be provided by using the rotational speed of the radiator fan. In this case, correction is made such that the cooling water temperature decreases faster as the rotational speed of the radiator fan increases. In an automobile in which a radiator fan is shared by the heat exchanger for air-conditioning and the radiator for the fuel cell, the radiator fan speed may be dictated by air-conditioning needs. Thus, the influence of the radiator fan can be taken into consideration. The third embodiment may also be combined with the first embodiment or the second embodiment.

With the above-described third embodiment, when the predicted value of the radiator cooling water temperature, predicted based on the outside air temperature and the vehicle speed, decreases to a predetermined temperature (i.e., a temperature which may cause a thermal impact to be generated in the fuel cell when the power generation is resumed) within a predetermined time (for example, 5 minutes, or a power generation stop duration, being a maximum time in which the power generation can be continuously stopped), the cooling water pump 15 does not decrease the supply of coolant to the fuel cell coolant paths. Thus, the rotational speed of the cooling water pump can be prevented from varying in a short time, and a user (or a driver of a vehicle) can be prevented from feeling uncomfortable as a result of a frequent variation in the pump rotational speed.

### Fourth Embodiment

Next, a fuel cell system according to a fourth embodiment of the present invention is described. In the fourth embodiment, the cooling water temperature sensor 20c is not used, similarly to the second embodiment. This embodiment employs a method of predicting the cooling water temperature in the radiator 17 based on a detection value of the outside air temperature sensor 25 which detects an ambient temperature of the air outside the radiator 17, instead of using the cooling water temperature sensor 20c which detects the cooling water temperature in the radiator 17. The general configuration of the fuel cell system is similar to that of the first embodiment shown in FIG. 1 except that the cooling water temperature sensor 20c is not necessary. Also, the configuration of the controller 30 is similar to the example configuration of the first embodiment shown in FIG. 2 except that a predicted value of the radiator cooling water temperature is used instead of the detected radiator cooling water temperature.

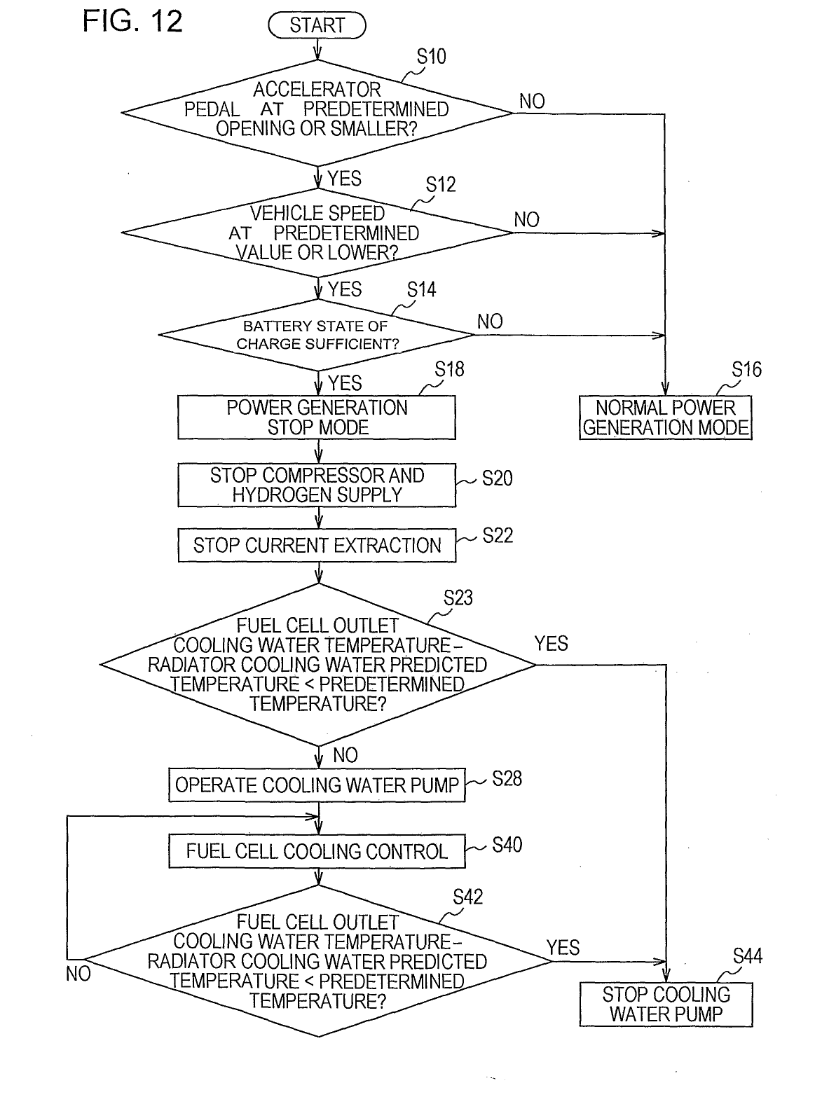

FIG. 12 is a flowchart showing a control process of the controller 30 according to the fourth embodiment. In FIG. 12, steps S10 through S23 are similar to those in the second embodiment. The fourth embodiment is different from the second embodiment in that steps of S40 and S42 are added.

In step S23, a predicted value of the radiator cooling water temperature after a predetermined time elapses is calculated, and it is determined whether or not a difference between the fuel cell outlet cooling water temperature and the predicted value is smaller than a predetermined temperature difference. If the temperature difference is smaller than the predetermined temperature difference, as determined in step S23, the process goes to step S44, in which the cooling water pump 15 is stopped.

If the difference between the fuel cell outlet cooling water temperature and the predicted value of the radiator cooling water temperature after the predetermined time elapses is the predetermined temperature difference or greater, as determined in step S23, the process goes to step S28, in which the operation of the cooling water pump 15 is continued. Then, fuel cell cooling control is performed in step S40. In the cooling control, amount of heat dissipated by the radiator 17 is increased by increasing the rotational speed of the cooling water pump 15, or by increasing the rotational speed of the radiator fan 18, and hence, the temperature of the fuel cell 1 detected by the fuel cell outlet temperature sensor 20b actively decreases.

Then, in step 42, similarly to step S23, the predicted value of the radiator cooling water temperature is calculated, and it is determined whether or not the difference between the fuel cell outlet cooling water temperature and the predicted value of the radiator cooling water temperature after the predetermined time elapses is smaller than the predetermined temperature difference. If the temperature difference is smaller than the predetermined temperature difference, as determined in step S42, the process goes to step S44, in which the cooling water pump 15 is stopped. If the temperature difference is the predetermined temperature difference or greater, as determined in step S42, the process returns to step S40, in which the cooling control of the fuel cell 1 is continued.

With the above-described fourth embodiment, if it is expected that the temperature difference is generated when the temperature of the fuel cell is high and the rotational speed of the cooling water pump decreases, the fuel efficiency of the fuel cell can be increased by actively decreasing the rotational speed of the cooling water pump 15 and increasing the amount of heat dissipated by the cooling water from the radiator 17 by, for example, increasing the speed of the radiator cooling fan 18.

### Fifth Embodiment

Next, a fuel cell system according to a fifth embodiment of the present invention is described. In the fifth embodiment, the cooling water temperature sensor 20c is not used, similarly to the second embodiment. This embodiment employs a method of predicting a cooling water temperature in the radiator 17 based on a detection value of the outside air temperature sensor 25 which detects an ambient temperature of the air outside the radiator 17, instead of using the cooling water temperature sensor 20c which detects the cooling water temperature in the radiator 17. The general configuration of the fuel cell system is similar to that of the first embodiment shown in FIG. 1 except that the cooling water temperature sensor 20c is not necessary. Also, the configuration of the controller 30 is similar to the example configuration of the first embodiment shown in FIG. 2 except that a predicted value of the radiator cooling water temperature is used instead of the detected radiator cooling water temperature.

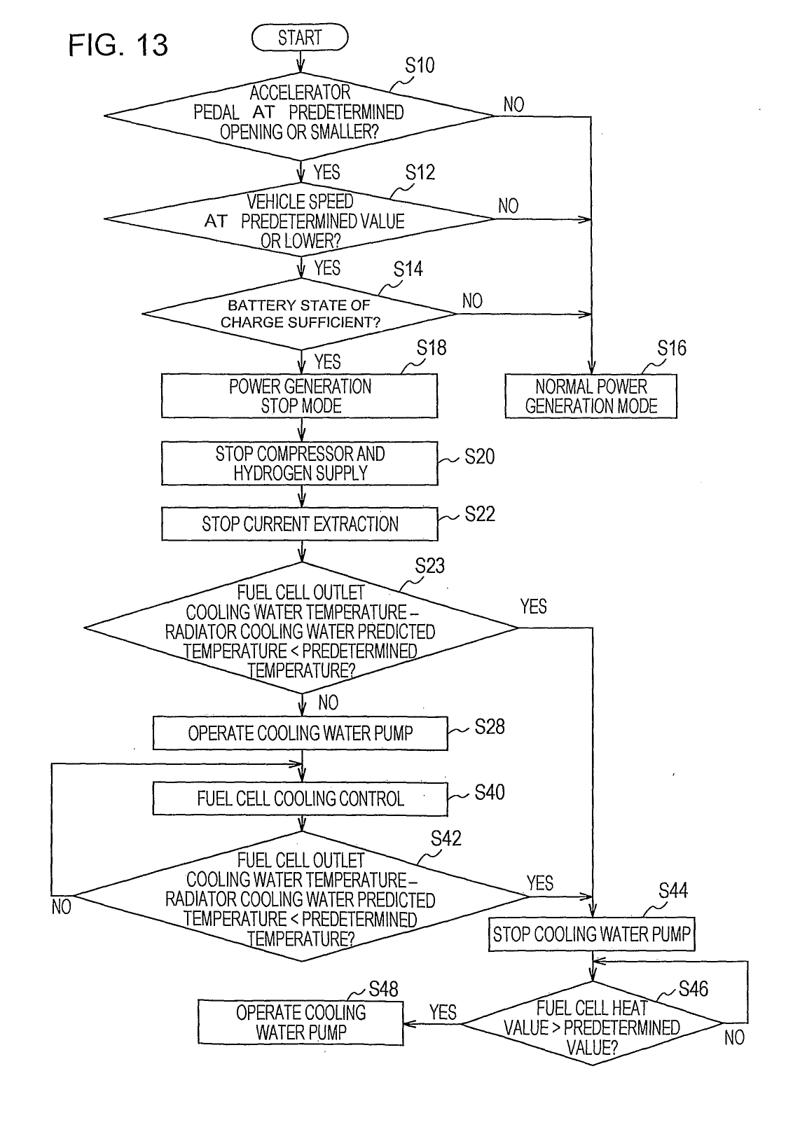

FIG. 13 is a flowchart showing a control process of the controller 30 according to the fifth embodiment. In FIG. 13, steps S10 through S44 are similar to those in the fourth embodiment. The fifth embodiment is different from the fourth embodiment in that steps of S46 and S48 are added.

In step S44, the cooling water pump 15 is stopped. Then, in step S46, a fuel cell outlet (or inlet) cooling water temperature is detected, and a radiator cooling water temperature is detected or predicted. It is determined whether or not the difference between the fuel cell outlet temperature and the radiator cooling water temperature exceeds a predetermined value. For the determination in S46, a heat value of the fuel cell may be calculated, for example, by detecting a generated current by the power manager 34 or a voltage of the fuel cell 1. When the heat value of the fuel cell is used, it is determined whether or not the heat value of the fuel cell exceeds a predetermined value. With the determination, it can be detected whether or not the power generation by the fuel cell is being performed, even in the power generation stop mode due to an erroneous operation of the power manager 34.

In the determination in step S46, if the difference between the fuel cell outlet temperature and the radiator cooling water temperature exceeds the predetermined value, or if the heat value of the fuel cell exceeds the predetermined value, the process goes to step S48, in which the cooling water pump 15 is operated. Thus, when the power generation with the fuel cell is performed even in the power generation stop mode, the difference between the fuel cell temperature and the radiator cooling water temperature can be prevented from being generated when the operation of the cooling water pump 15 is resumed.

The cooling water pump 15 is stopped merely using the fuel cell temperature and the radiator cooling water temperature in this embodiment. However, in a case in which the cooling water pump 15 is cooled by using cooling water for the fuel cell, in order to prevent the cooling water pump or cooling water from overheating, determination and control may be additionally provided such that the cooling water pump is not stopped if a cooling water temperature exceeds a predetermined temperature.

With the above-described fifth embodiment, in a case in which the power generation is performed by an erroneous operation of the power manager although the operation mode is the power generation stop mode and thus the power generation should not be performed, when the fuel cell cooling water temperature increases and the cooling water pump rotational speed increases, the temperature difference can be prevented from being generated in the fuel cell coolant path.

While the invention has been disclosed with reference to certain preferred embodiments, numerous modifications, alterations, and changes to the described embodiments are possible without departing from the sphere and scope of the invention, as defined in the appended claims and equivalents thereof. Accordingly, it is intended that the invention not be limited to the described embodiments, but that it have the full scope defined by the language of the following claims.

What is claimed is:

1. A fuel cell system comprising:
a fuel cell configured to operate in an operation mode selected from a power generation mode and a power generation stop mode;
a coolant supply device for circulating an amount of coolant through a coolant path for cooling the fuel cell;
a fuel cell temperature detector for detecting a fuel cell temperature of the fuel cell;
a coolant temperature detector for detecting a coolant temperature of the coolant in the coolant path; and
a controller for controlling the amount of coolant circulated by the coolant supply device, selecting the operation mode of the fuel cell between the power generation mode and the power generation stop mode, and calculating the difference between the detected coolant temperature and detected fuel cell temperature;
wherein while the operation mode of the fuel cell is selected to be the power generation stop mode the controller increases the amount of the coolant circulated as the difference between the detected coolant temperature and the detected fuel cell temperature increases.

2. The fuel cell system according to claim 1 further comprising:
a heat exchanger located in the coolant path for dissipating an amount of heat from the coolant after the coolant passes through the fuel cell;
wherein the coolant temperature detector detects the coolant temperature of the coolant at the heat exchanger.

3. The fuel cell system according to claim 1, wherein:
the fuel cell is configured to supply electrical power to a vehicle.

4. The fuel cell system according to claim 3 further comprising:
a power storage unit;
wherein the fuel cell supplies power to the vehicle when the controller selects the power generation mode; and
wherein the power storage unit supplies power to the vehicle when the controller selects the power generation stop mode.

5. The fuel cell system according to claim 4, wherein:
the power is supplied either to the vehicle or to the power storage unit based on at least one of a detected speed of the vehicle, a detected accelerator opening amount, and a condition of the power storage unit.

6. The fuel cell system according to claim 2, further comprising:
an ambient temperature detector configured to detect an ambient temperature of outside air at the heat exchanger;
wherein the coolant temperature detector predicts the coolant temperature based on the detected ambient temperature.

7. The fuel cell system according to claim 6, wherein:
the controller prevents the amount of coolant being circulated by the coolant supply device from decreasing when the coolant temperature is predicted to decrease to a predetermined temperature within a predetermined time after the controller changes the selected operation mode from the power generation mode to the power generation stop mode.

8. The fuel cell system according to claim 7, wherein:
the controller causes the amount of heat dissipated by the heat exchanger to increase when the controller prevents the amount of coolant being circulated from decreasing.

9. A fuel cell system comprising:
a fuel cell configured to operate in an operation mode selected from a power generation mode and a power generation stop mode;
coolant supply means for circulating an amount of coolant through a coolant flow path for cooling the fuel cell;
fuel cell temperature detection means for detecting a fuel cell temperature of the fuel cell;
coolant temperature detection means for detecting a coolant temperature of the coolant in the coolant flow path; and
control means for controlling the amount of coolant circulated by the coolant supply means, selecting the operation mode of the fuel cell between the power generation mode and the power generation stop mode, and calculating the difference between the detected coolant temperature and detected fuel cell temperature;
wherein while the operation mode of the fuel cell is selected to be the power generation stop mode, the amount of coolant circulated increases as the difference between the detected coolant temperature and the detected fuel cell temperature increases.

10. The fuel cell system according to claim 9 further comprising:
heat exchange means for dissipating an amount of heat from the coolant circulated through the coolant flow path after the coolant passes through the fuel cell;
wherein the coolant temperature detection means detects the coolant temperature of the coolant at the heat exchange means.

11. The fuel cell system according to claim 9, wherein:
the fuel cell is configured to supply electrical power to a vehicle.

12. The fuel cell system according to claim 11 further comprising:
power storage means;
wherein the fuel cell supplies power to the vehicle when the controller selects the power generation mode; and
wherein the power storage means supplies power to the vehicle when the controller selects the power generation stop mode.

13. The fuel cell system according to claim 12, wherein:
the power is supplied to either the vehicle or the power storage means based on at least one of a detected speed of the vehicle, a detected accelerator opening amount, and a condition of the power storage means.

14. The fuel cell system according to claim 10, further comprising:
ambient temperature detection means configured to detect an ambient temperature of outside air at the heat exchange means;
wherein the coolant temperature detection means predicts the coolant temperature based on the detected ambient temperature.

15. The fuel cell system according to claim 14, wherein:
the control means prevents the amount of coolant being circulated by the coolant supply means from decreasing when the coolant temperature is predicted to decrease to a predetermined temperature within a predetermined time after the selected operation mode changes from the power generation mode to the power generation stop mode.

16. The fuel cell system according to claim 15, wherein:
the control means causes the amount of heat dissipated by the heat exchange means to increase when the control means prevents the amount of coolant being circulated from decreasing.

17. A method for preventing thermal shock to a fuel cell in a fuel cell system, the method comprising:
circulating an amount of coolant to cool the fuel cell;
detecting a fuel cell temperature of the fuel cell;
detecting a coolant temperature of the coolant;
selecting an operation mode of the fuel cell to be one of a power generation mode and a power generation stop mode; and
controlling the amount of coolant circulated to the fuel cell to increase as the difference between the detected coolant temperature and the detected fuel cell temperature increases, when the power generation stop mode is selected.

18. The method according to claim 17, further comprising:
detecting the coolant temperature of the coolant at a heat exchanger configured to dissipate an amount of heat from the coolant being circulated to cool the fuel cell.

19. The method according to claim 17, further comprising:
supplying electricity generated by the fuel cell to a vehicle when the power generation mode is selected; and
supplying electricity generated by the fuel cell to a power storage device when the power generation stop mode is selected.

20. The method according to claim 17, wherein detecting the coolant temperature comprises:
detecting an ambient temperature of outside air at the heat exchanger; and
predicting the coolant temperature based on the detected ambient temperature.

21. The method according to claim 20, further comprising:
preventing the amount of coolant being circulated from decreasing when the coolant temperature is predicted to decrease to a predetermined temperature within a predetermined time after the selected operation mode changes from the power generation mode to the power generation stop mode.
